(19) United States
(12) Patent Application Publication
(10) Pub. No.: US 2005/0182170 A1
(43) Pub. Date: Aug. 18, 2005

(54) Poly(arylene ether) composition

(76) Inventors: Biswaroop Majumdar, Glenmont, NY (US); Kristopher Rexius, Waterford, MI (US); Sai-Pei Ting, Slingerlands, NY (US)

Correspondence Address: CANTOR COLBURN, LLP, 55 GRIFFIN ROAD SOUTH, BLOOMFIELD, CT, 06002, US

(21) Appl. No.: 10/778,803

(22) Filed: Feb. 13, 2004

(51) Int. Cl. C08K 5/04; C08K 3/04

(52) U.S. Cl. 524/394; 524/495

(57) ABSTRACT

A thermoplastic composition comprises a poly(arylene ether), a polyamide, a metal stearate and a polyolefin comprising functional groups reactive with the polyamide.

### BACKGROUND OF INVENTION

The disclosure relates to poly(arylene ether) compositions. In particular, the invention relates to poly(arylene ether)/polyamide compositions.

Compositions containing a combination of poly(arylene ether) and polyamide have been widely used, particularly in molded parts, due to the combination of the most desirable properties of each material such as heat resistance, dimensional stability, strength, and chemical resistance.

Under some conditions, injection molded parts made from poly(arylene ether)/polyamide compositions can exhibit surface imperfections or part failure typically resulting from insufficient mold release, insufficient melt viscosity or a combination of insufficient mold release and melt viscosity. Insufficient melt viscosity can result in the mold being filled incompletely, particularly with complex parts. Insufficient mold release can be particularly problematic in articles having complex shapes and/or thin walled areas because they are more susceptible to failure when increased force is used to eject the part from the mold. Previous attempts to improve mold release have focused on the use of metal stearates but metal stearates can have a negative impact on physical properties such as impact strength.

Thus there is a continuing need for a poly(arylene ether)/polyamide composition with excellent mold release properties without a negative impact on other physical properties.

### BRIEF DESCRIPTION OF THE INVENTION

A thermoplastic composition comprises a poly(arylene ether), a polyamide, a metal stearate and a polyolefin comprising functional groups reactive with the polyamide.

### DETAILED DESCRIPTION

A thermoplastic composition comprises a poly(arylene ether), a polyamide, a metal stearate and a polyolefin comprising functional groups reactive with the polyamide. The composition may further comprise an impact modifier. The composition exhibits excellent impact strength as well as good mold release properties thereby enabling the formation of complex parts having excellent physical properties and few or no surface imperfections.

In one embodiment the thermoplastic composition has a melt viscosity greater than or equal to about 130 and preferably greater than or equal to about 140 Pascal seconds (Pas) when determined at 282° C. and a 1500 reciprocal seconds shear rate. The composition has a Dynatup impact strength (in joule, tested at 23° C.) greater than or equal to about 30 as determined according to ASTM D3763 The composition also has an ejector pressure less than or equal to about 1100 kilopascals when measured upon ejection of a four-way connector.

The term poly(arylene ether) includes polyphenylene ether (PPE) and poly(arylene ether) copolymers; graft copolymers; poly(arylene ether) ether ionomers; and block copolymers of alkenyl aromatic compounds, vinyl aromatic compounds, and poly(arylene ether), and the like; and combinations comprising at least one of the foregoing; and the like. Poly(arylene ether)s per se, are known polymers comprising a plurality of structural units of the formula (I): 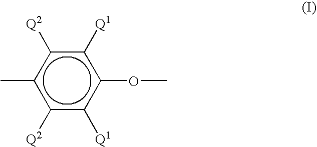
wherein for each structural unit, each Q¹ is independently hydrogen, halogen, primary or secondary lower alkyl (e.g., alkyl containing up to 7 carbon atoms), phenyl, haloalkyl, aminoalkyl, hydrocarbonoxy, halohydrocarbonoxy wherein at least two carbon atoms separate the halogen and oxygen atoms, or the like; and each Q² is independently hydrogen, halogen, primary or secondary lower alkyl, phenyl, haloalkyl, hydrocarbonoxy, halohydrocarbonoxy wherein at least two carbon atoms separate the halogen and oxygen atoms, or the like. Preferably, each Q¹ is alkyl or phenyl, especially C₁₋₄ alkyl, and each Q² is hydrogen.

In one embodiment, the monohydroxyphenol is 2,6-dimethylphenol having a purity of greater than about 99 weight percent, preferably greater than about 99.67 weight percent, and more preferably greater than about 99.83 weight percent based on the total weight of the monohydroxyphenol. Additionally, the 2,6-dimethylphenol preferably comprises less than about 0.11 weight percent anisole and more preferably less than about 0.067 weight percent anisole. Anisole includes, for example, anisole, 2-methylanisole, 4-methylanisole, 2,4-dimethylanisole, 2,6-dimethylanisole, 2,4,6-trimethylanisole, or a combination comprising at least one of the foregoing anisoles. The 2,6-dimethylphenol also preferably comprises less than about 0.090 weight percent of other organic impurities and more preferably less than about 0.065 weight percent. Particular other organic impurities include, for example, 2,6-dimethylcyclohexanone, 7-methyl(2,3)dihydrobenzofuran, and (2,3)dihydrobenzofuran. Minimizing the quantity of anisole and other organic impurities is believed to reduce the odor of the resulting poly(phenylene ether).

Both homopolymer and copolymer poly(arylene ether) are included. The preferred homopolymers are those containing 2,6-dimethylphenylene ether units. Suitable copolymers include random copolymers containing, for example, such units in combination with 2,3,6-trimethyl-1,4-phenylene ether units or copolymers derived from copolymerization of 2,6-dimethylphenol with 2,3,6-trimethylphenol. Also included are poly(arylene ether) containing moieties prepared by grafting vinyl monomers or polymers such as polystyrenes, as well as coupled poly(arylene ether) in which coupling agents such as low molecular weight polycarbonates, quinones, heterocycles and formals undergo reaction in known manner with the hydroxy groups of two poly(arylene ether) chains to produce a higher molecular weight polymer. Poly(arylene ether)s of the present invention further include combinations comprising at least one of the above.

The poly(arylene ether) generally has a number average molecular weight of about 3,000-40,000 atomic mass units (amu) and a weight average molecular weight of about 20,000-80,000 amu, as determined by gel permeation chromatography. The poly(arylene ether) may have an intrinsic viscosity of about 0.10 to about 0.60 deciliters per gram (dl/g), preferably about 0.29 to about 0.48 dl/g, as measured in chloroform at 25° C. It is also possible to utilize a high intrinsic viscosity poly(arylene ether) and a low intrinsic viscosity poly(arylene ether) in combination. Determining an exact ratio, when two intrinsic viscosities are used, will depend somewhat on the exact intrinsic viscosities of the poly(arylene ether) used and the ultimate physical properties that are desired.

Poly(arylene ether)s are typically prepared by the oxidative coupling of at least one monohydroxyaromatic compound such as 2,6-xylenol or 2,3,6-trimethylphenol. Catalyst systems are generally employed for such coupling; they typically contain at least one heavy metal compound such as a copper, manganese or cobalt compound, usually in combination with various other materials.

Particularly useful poly(arylene ether)s for many purposes are those which comprise molecules having at least one aminoalkyl-containing end group. The aminoalkyl radical is typically located in an ortho position to the hydroxy group. Products containing such end groups may be obtained by incorporating an appropriate primary or secondary monoamine such as di-n-butylamine or dimethylamine as one of the constituents of the oxidative coupling reaction mixture. Also frequently present are 4-hydroxybiphenyl end groups, typically obtained from reaction mixtures in which a by-product diphenoquinone is present, especially in a copper-halide-secondary or tertiary amine system. A substantial proportion of the polymer molecules, typically constituting as much as about 90% by weight of the polymer, may contain at least one of said aminoalkyl-containing and 4-hydroxybiphenyl end groups.

Based upon the foregoing, it will be apparent to those skilled in the art that the contemplated poly(arylene ether) resin may include many of those poly(arylene ether) resins presently known, irrespective of variations in structural units or ancillary chemical features.

The poly(arylene ether) is present in an amount of about 20 to about 65 weight percent based on the total weight of resin. Total weight of resin is herein defined as the total weight of poly(arylene ether), polyamide, functionalized polyolefin and optional impact modifier. Within this range the poly(arylene ether) may be present in an amount greater than or equal to about 25, preferably greater than or equal to about 30 and more preferably greater than or equal to about 35 weight percent. Also within this range the poly(arylene ether) may be present in an amount less than or equal to about 60, preferably less than or equal to about 55 and more preferably less than or equal to about 50 weight percent.

Polyamides are a generic family of resins known as nylons, characterized by the presence of an amide group (—C(O)NH—). Nylon-6 and nylon-6,6 are the generally preferred polyamides and are available from a variety of commercial sources. Other polyamides, however, such as nylon-4,6, nylon-12, nylon-6,10, nylon 6,9, nylon 9T, nylon 6/9T, nylon 6,6/9T, nylon 6/6T and nylon 6,6/6T with triamine contents below about 0.5 weight percent, as well as others, such as the amorphous nylons may be useful for particular PPE-polyamide applications. Mixtures of various polyamides, as well as various polyamide copolymers, are also useful. The most preferred polyamide is polyamide-6,6.

The polyamides can be obtained by a number of well-known processes such as those described in U.S. Pat. Nos. 2,071,250; 2,071,251; 2,130,523; 2,130,948; 2,241,322; 2,312,966; and 2,512,606. Nylon-6, for example, is a polymerization product of caprolactam. Nylon-6,6 is a condensation product of adipic acid and 1,6-diaminohexane. Likewise, nylon 4,6 is a condensation product between adipic acid and 1,4-diaminobutane. Besides adipic acid, other useful diacids for the preparation of nylons include azelaic acid, sebacic acid, dodecane diacid, as well as terephthalic and isophthalic acids, and the like. Other useful diamines include m-xylene diamine, di-(4-aminophenyl)methane, di-(4-aminocyclohexyl)methane; 2,2-di-(4-aminophenyl)propane, 2,2-di-(4-aminocyclohexyl)propane, among others. Copolymers of caprolactam with diacids and diamines are also useful.

Polyamides having viscosity of up to about 400 ml/g can be used, with a viscosity of about 90 to about 350 ml/g preferred, and about 110 to about 240 ml/g especially preferred, as measured in a 0.5 wt % solution in 96 wt % sulphuric acid in accordance with ISO 307.

The polyamide is present in an amount of about 35 to about 80 weight percent based on the total weight of resin. Within this range the polyamide may be present in an amount greater than or equal to about 40, preferably greater than or equal to about 45 and more preferably greater than or equal to about 50 weight percent. Also within this range the polyamide may be present in an amount less than or equal to about 75, preferably less than or equal to about 70 and more preferably less than or equal to about 65 weight percent.

The composition may, optionally, comprise a compatibilizing agent to improve the physical properties of the poly(arylene ether)-polyamide resin blend, as well as to enable the use of a greater proportion of the polyamide component. When used herein, the expression “compatibilizing agent” refers to those polyfunctional compounds which interact with the polyphenylene ether, the polyamide, or, preferably, both. This interaction may be chemical (e.g. grafting) or physical (e.g. affecting the surface characteristics of the dispersed phases). In either case the resulting poly(arylene ether)-polyamide composition appears to exhibit improved compatibility, particularly as evidenced by enhanced impact strength, mold knit line strength and/or elongation. As used herein, the expression “compatibilized poly(arylene ether)-polyamide base resin” refers to those compositions which have been physically or chemically compatibilized with an agent as discussed above, as well as those compositions which are physically compatible without such agents, as taught, for example, in U.S. Pat. No. 3,379,792.

Suitable compatibilizing agents include, for example, liquid diene polymers, epoxy compounds, oxidized polyolefin wax, quinones, organosilane compounds, polyfunctional compounds, and functionalized poly(arylene ether)s obtained by reacting one or more of the previously mentioned compatibilizing agents with poly(arylene ether).

The foregoing compatibilizing agents may be used alone or in various combinations of one another with another. Furthermore, they may be added directly to the melt blend or pre-reacted with either or both the poly(arylene ether) and polyamide, as well as with other resinous materials employed in the preparation of the compositions of the present invention. With many of the foregoing compatibilizing agents, particularly the polyfunctional compounds, even greater improvement in compatibility is found where at least a portion of the compatibilizing agent is pre-reacted, either in the melt or in a solution of a suitable solvent, with all or a part of the poly(arylene ether). It is believed that such pre-reacting may cause the compatibilizing agent to react with the polymer and, consequently, functionalize the poly(arylene ether) as noted above. For example, the poly(arylene ether) may be pre-reacted with maleic anhydride to form an anhydride functionalized poly(arylene ether) which has improved compatibility with the polyamide compared to a non-functionalized poly(arylene ether).

Where the compatibilizing agent is employed, the initial amount used will be dependent upon the specific compatibilizing agent chosen and the specific polymeric system to which it is added.

When present, the compatibilizing agent may be present in an amount of about 0.01 weight percent to about 25 weight percent based on the total weight of resin. Within this range, it may be preferred to use a compatibilizing agent in an amount greater than or equal to about 0.2 weight percent, preferably greater than or equal to about 0.4 weight percent. Also within this range, it may be preferred to use a compatibilizing agent in an amount less than or equal to about 10 weight percent, more preferably less than or equal to about 3 weight percent.

The metal stearate is preferably zinc stearate, calcium stearate, aluminum stearate, cerium stearate, magnesium stearate or a combination of two or more of the foregoing. Metal stearates are available commercially and there preparation is known in the art.

The metal stearate is present in an amount of about 0.05 to about 1.0 weight percent based on the total weight of resin. Within this range the metal stearate may be present in an amount greater than or equal to about 0.08, preferably greater than or equal to about 0.1 weight percent. Also within this range the metal stearate may be present in an amount less than or equal to about 0.8, preferably less than or equal to about 0.6 weight percent. In one embodiment the metal stearate is dryblended with the poly(arylene ether) prior to compounding.

The polyolefin comprises functional groups reactive with the polyamide. Exemplary functional groups include carboxylic acid groups, esters, acid anhydrides, epoxy groups, oxazoline groups, carbodiimide groups, isocyanate groups, silanol groups and carboxylates. The polyolefin may comprise more than one type of functional group. A preferred functional group is maleic anhydride. The polyolefin is a polyolefin miscible with the polyamide and includes linear random copolymers, linear block copolymer and core-shell type copolymers wherein the shell is miscible with polyamide and comprises a functional group reactive with the polyamide. Exemplary polyolefins include polyethylene, ethylene-vinyl acetate copolymer (EVA), ethylene-ethylacrylate copolymer (EEA), ethylene-octene copolymer, ethylene-propylene copolymer, ethylenebutene copolymer, ethylene-hexene copolymer, or ethylene-propylene-diene terpolymer. Monomers comprising the functional group may be graft-polymerized with the polyolefin or co-polymerized with the polyolefin monomers. Functionalized polyolefins are commercially available.

In one embodiment, the polyolefin is ethylene-propylene functionalized with maleic anhydride. Preferably the ethylene-propylene is functionalized with maleic anhydride in an amount of about 0.1 to about 3.0 weight percent based on the total weight of the functionalized polyolefin. Within this range the ethylene-propylene may be functionalized with maleic anhydridr in an amount greater than or equal to about 0.2 and preferably greater than or equal to about 0.3 weight percent. Also within this range the ethylene-propylene may be functionalized with maleic anhydride in an amount less than or equal to about 2.0 and preferably less than or equal to about 1.0 weight percent.

The functionalized polyolefin is present in an amount of about 1 to about 15 weight percent based on the total weight of resin. Within this range the functionalized polyolefin may be present in an amount greater than or equal to about 2, preferably greater than or equal to about 3 and more preferably greater than or equal to about 4 weight percent. Also within this range the functionalized polyolefin may be present in an amount less than or equal to about 10, preferably less than or equal to about 7 weight percent.

The composition preferably further comprises an impact modifier. Particularly suitable thermoplastic impact modifiers are block copolymers, for example, A-B diblock copolymers and A-B-A triblock copolymers having of one or two alkenyl aromatic blocks A, which are typically styrene blocks, and a rubber block, B, which is typically an isoprene or butadiene block. The butadiene block may be partially hydrogenated. Mixtures of these diblock and triblock copolymers are especially useful.

Suitable A-B and A-B-A copolymers include but are not limited to polystyrene-polybutadiene, polystyrene-poly(ethylene-propylene), polystyrene-polyisoprene, poly(α-methylstyrene)-polybutadiene, polystyrene-polybutadiene-polystyrene (SBS), polystyrene-poly(ethylene-propylene)-polystyrene, polystyrene-polyisoprene-polystyrene and poly(alpha-methylstyrene)-polybutadiene-poly(alpha-methylstyrene), as well as the selectively hydrogenated versions thereof, and the like. Mixtures of the aforementioned block copolymers are also useful. Such A-B and A-B-A block copolymers are available commercially from a number of sources, including Phillips Petroleum under the trademark SOLPRENE, Shell Chemical Co., under the trademark KRATON, Dexco under the trademark VECTOR, and Kuraray under the trademark SEPTON.

The impact modifier may be present in an amount up to about 20 weight percent based on the total weight of resin. Within this range the impact modifier may be present in an amount greater than or equal to about 2 weight percent, preferably greater than or equal to about 4 weight percent. Also within this range the impact modifier may be present in an amount less than or equal to about 15 weight percent, preferably less than or equal to about 10 weight percent.

The composition can also include effective amounts of at least one additive selected from the group consisting of anti-oxidants, flame retardants, drip retardants, dyes, pigments, colorants, stabilizers, small particle mineral such as clay, mica, and talc, antistatic agents, plasticizers, lubricants, fillers, reinforcing agents, and mixtures thereof. These additives are known in the art, as are their effective levels and methods of incorporation. Effective amounts of the additives vary widely, but they are usually present in an amount up to about 50% or more by weight, based on the weight of the entire composition.

In one embodiment the composition comprises carbon black in an amount of about 0.01 to about 25 weight percent based on the total weight of resin. Within this range the amount of carbon black may be greater than or equal to about 0.2 and preferably greater than or equal to about 0.4 weight percent. Also within this range the amount of carbon black may be less than or equal to about 10 and preferably less than or equal to about 3 weight percent.

The preparation of the composition is normally achieved by blending the ingredients under conditions for the formation of an intimate blend. Such conditions often include mixing in single or twin screw type extruders or similar mixing devices which can apply a shear to the components.

All of the ingredients may be added initially to the processing system, or else certain additives may be precompounded with one or more of the primary components, preferably the poly(arylene ether), impact modifier (when present) and the polyamide. It appears that certain properties, such as impact strength and elongation, are sometimes enhanced by initially precompounding the poly(arylene ether) and impact modifier, optionally with any other ingredients such as metal stearate, prior to compounding with the polyamide resin, however, these improvements are done at the expense of increasing the viscosity of the compatibilized composition. It is preferable that greater than or equal to about 5 weight percent, preferably greater than or equal to about 8 weight percent, more preferably greater than or equal to about 10 weight percent polyamide and most preferably greater than or equal to about 15 weight percent polyamide, based on the total weight of the polyamide be added with the poly(arylene ether) and compatibilizing agent such as a non-polymeric carboxylic acid. The remaining portion of the polyamide is fed through a port downstream. In this manner, the viscosity of the compatibilized composition is reduced without significant reduction in other key physical properties. The functionalized polyolefin may be added with the poly(arylene ether), the polyamide or in a separate location. Preferably the functionalized polyolefin is added downstream of the compatibilizing agent.

While separate extruders may be used in the processing, these compositions are preferably prepared by using a single extruder having multiple feed ports along its length to accommodate the addition of the various components. It is often advantageous to apply a vacuum to the melt through at least one or more vent ports in the extruder to remove volatile impurities in the composition. Those of ordinary skill in the art will be able to adjust blending times and temperatures, as well as component addition, without undue additional experimentation.

The compositions may be converted to articles using common thermoplastic processes such as film and sheet extrusion, injection molding, gas-assist injection molding, extrusion molding, compression molding and blow molding. Film and sheet extrusion processes may include and are not limited to melt casting, blown film extrusion and calendaring. Co-extrusion and lamination processes may be employed to form composite multi-layer films or sheets. Single or multiple layers of coatings may further be applied to the single or multi-layer substrates to impart additional properties such as scratch resistance, ultra violet light resistance, aesthetic appeal, etc. Coatings may be applied through standard application techniques such as rolling, spraying, dipping, brushing, or flow-coating. Film and sheet of the invention may alternatively be prepared by casting a solution or suspension of the composition in a suitable solvent onto a substrate, belt or roll followed by removal of the solvent.

Oriented films may be prepared through blown film extrusion or by stretching cast or calendared films in the vicinity of the thermal deformation temperature using conventional stretching techniques. For instance, a radial stretching pantograph may be employed for multi-axial simultaneous stretching; an x-y direction stretching pantograph can be used to simultaneously or sequentially stretch in the planar x-y directions. Equipment with sequential uniaxial stretching sections can also be used to achieve uniaxial and biaxial stretching, such as a machine equipped with a section of differential speed rolls for stretching in the machine direction and a tenter frame section for stretching in the transverse direction.

The thermoplastic composition may be converted to multiwall sheet comprising a first sheet having a first side and a second side, wherein the first sheet comprises a thermoplastic polymer, and wherein the first side of the first sheet is disposed upon a first side of a plurality of ribs; and a second sheet having a first side and a second side, wherein the second sheet comprises a thermoplastic polymer, wherein the first side of the second sheet is disposed upon a second side of the plurality of ribs, and wherein the first side of the plurality of ribs is opposed to the second side of the plurality of ribs.

The films and sheets described above may further be thermoplastically processed into shaped articles via forming and molding processes including but not limited to thermoforming, vacuum forming, pressure forming, injection molding and compression molding. Multi-layered shaped articles may also be formed by injection molding a thermoplastic resin onto a single or multi-layer film or sheet substrate as follows: 1. Providing a single or multi-layer thermoplastic substrate having optionally one or more colors on the surface, for instance, using screen printing or a transfer dye; 2. Conforming the substrate to a mold configuration such as by forming and trimming a substrate into a three dimensional shape and fitting the substrate into a mold having a surface which matches the three dimensional shape of the substrate; and 3. Injecting a thermoplastic resin into the mold cavity behind the substrate to (i) produce a one-piece permanently bonded three-dimensional product or (ii) transfer a pattern or aesthetic effect from a printed substrate to the injected resin and remove the printed substrate, thus imparting the aesthetic effect to the molded resin.

Those skilled in the art will also appreciate that common curing and surface modification processes including and not limited to heat-setting, texturing, embossing, corona treatment, flame treatment, plasma treatment and vacuum deposition may further be applied to the above articles to alter surface appearances and impart additional functionalities to the articles.

Accordingly, another embodiment relates to articles, sheets and films prepared from the compositions above.

The composition is further illustrated by the following non-limiting examples.

### EXAMPLES

### Examples 1-9

Compositions were made by melt mixing 30 weight percent polyphenylene ether, 0.7 weight percent citric acid, 0.85 weight percent additives, 57 weight percent polyamide (nylon 66 available from Rhodia), and 1.0 weight percent of a carbon black-polyamide masterbatch (20 weight percent carbon black/80 weight percent polyamide) with impact modifier, calcium stearate and functionalized polyolefin which were varied as shown in Table 1. The impact modifier was a polystyrene-poly (ethylene-propylene) available from Kraton as KG1701X. The functionalized polyolefin was an ethylene-propylene-graft-maleic anhydride (EP-g-MA) copolymer available as EXXELOR VA1801 from Exxon. Dynatup impact strength (in joule, tested at 23° C.) was determined according to ASTM D3763. Mold release properties were determined by injection molding a 4-way connector and measuring the ejector pressure required to remove the part. Ejector pressure is in kilo-Pascal. Melt viscosity (in Pascal seconds, Pas) of the composition was determined at 282° C. and a shear rate of 1500 reciprocal seconds.

TABLE 1

| | | | | | Melt | Ejector |
|---|---|---|---|---|---|---|
| | Impact | | EP- | Dynatup | viscosity | pressure |
| Exam- | modifier | Calcium | g- | (Joule) | (Pascal- | (kilo |
| ple | (KG1702X) | stearate | MA | @ 23° C. | sec) | Pascal) |
| 1* | 10 | 0 | 0 | 31.4 | 142 | 1622 |
| 2* | 10 | 0.1 | 0 | 39.3 | 133 | 1266 |
| 3* | 10 | 0.3 | 0 | 29.9 | 130 | 1111 |
| 4* | 10 | 0.6 | 0 | 20.1 | 119 | 1191 |
| 5* | 5 | 0 | 5 | 29.2 | 156 | 1076 |
| 6* | 0 | 0 | 10 | 36.6 | 161 | 919 |
| 7 | 5 | 0.1 | 5 | 36.8 | 147 | 1005 |
| 8 | 5 | 0.3 | 5 | 35.1 | 143 | 990 |
| 9 | 5 | 0.6 | 5 | 32.1 | 134 | 948 |

*Comparative Examples

As can be seen from the foregoing examples, compositions comprising poly(arylene ether), polyamide, metal stearate, and functionalized polyolefin exhibit a desirable combination of mold release, impact strength and melt viscosity. Comparative examples 2-4 demonstrate that with increasing amounts of metal stearate the compositions have an undesirable decrease in impact strength (Dynatup) coupled with a desired decrease in mold release pressure and melt viscosity. Comparative examples 5 and 6, containing functionalized polyolefin in the absence of metal stearate demonstrate that while use of the functionalized polyolefin alone will decrease the mold release pressure and increase the impact strength, the melt viscosity is significantly increased. In contrast, Examples 7-9 containing the functionalized polyolefin and the metal stearate demonstrate a desired combination of impact strength, mold release and melt viscosity.

In one embodiment the composition has an impact strength that is greater than or equal to the impact strength of comparable poly(arylene ether)-polyamide composition free of metal stearates, functionalized polyolefins or combinations there of; a melt viscosity that is less than or equal to about 110% of the melt viscosity of comparable poly(arylene ether)-polyamide composition free of metal stearates, functionalized polyolefins or combinations there of; and/or an ejector pressure that is less than or equal to about 90% of the ejector pressure of a comparable poly(arylene ether)-polyamide composition free of metal stearates, functionalized polyolefins or combinations there of. A comparable composition is herein defined as one containing substantially similar amounts and types of poly(arylene ether), polyamide and impact modifier (when present) as the subject composition.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety.

1. A thermoplastic composition comprising a poly(arylene ether), a polyamide, a metal stearate and a polyolefin comprising functional groups reactive with the polyamide.

2. The composition of claim 1 wherein the metal stearate comprises zinc stearate, calcium stearate, aluminum stearate, cerium stearate, magnesium stearate or a combination of two or more of the foregoing

3. The composition of claim 1 wherein the functional groups comprise carboxylic acid groups, esters, acid anhydrides, epoxy groups, oxazoline groups, carbodiimide groups, isocyanate groups, silanol groups, carboxylates or a combination of two or more of the foregoing.

4. The composition of claim 1 wherein the functional groups comprise more than one type of functional group.

5. The composition of claim 1 wherein the polyolefin comprising functional groups reactive with the polyamide comprises ethylene-propylene-graft-maleic anhydride.

6. The composition of claim 1 wherein the poly(arylene ether) and polyamide are compatibilized.

7. The composition of claim 1 further comprising an additive.

8. The composition of claim 7 wherein the additive is carbon black.

9. The composition of claim 1 further comprising an impact modifier.

10. The composition of claim 9 wherein the impact modifier is a block copolymer.

11. The composition of claim 9 wherein the impact modifier is present in an amount up to about 20 weight percent based on the total weight of resin.

12. The composition of claim 1 wherein the poly(arylene ether) is present in an amount of about 20 to about 65 weight percent, based on the total weight of resin.

13. The composition of claim 1 wherein the polyamide is present in an amount of about 35 to about 80 weight percent, based on the total weight of resin.

14. The composition of claim 1 wherein the metal stearate is present in an amount of about 0.05 to about 1.0 weight percent, based on the total weight of resin.

15. The composition of claim 1 wherein the polyolefin comprising functional groups reactive with the polyamide is present in an amount of about 1 to about 15 weight percent, based on the total weight of resin.

16. The composition of claim 1 wherein the composition has a melt viscosity greater than or equal to about 130 Pascal seconds (Pas) when determined at 282° C. and a 1500 reciprocal seconds shear rate; a Dynatup impact strength (in joule, tested at 23° C.) greater than or equal to about 30 as determined according to ASTM D3763; and an ejector pressure less than or equal to about 1100 kilopascals when measured upon ejection of a four-way connector.

17. The composition of claim 1 wherein the composition has an impact strength greater than or equal to the impact strength of comparable poly(arylene ether)-polyamide composition free of metal stearates, functionalized polyolefins or combinations there of; a melt viscosity less than or equal to about 110% of the melt viscosity of comparable poly(arylene ether)-polyamide composition free of metal stearates, functionalized polyolefins or combinations there of; and an ejector pressure that is less than or equal to about 90% of the ejector pressure of a comparable poly(arylene ether)-polyamide composition free of metal stearates, functionalized polyolefins or combinations there of.

18. An article comprising the composition of claim 1.

19. The article of claim 18 comprising a film, sheet, molded object or composite.

20. The article of claim 19 wherein the film, sheet, molded object or composite has at least one layer comprising the composition of claim 1.

21. A thermoplastic composition produced by melt mixing a poly(arylene ether), a polyamide, a compatibilizing agent, a metal stearate and a polyolefin comprising functional groups reactive with the polyamide.

22. The composition of claim 21 wherein the poly(arylene ether), a portion of the polyamide, and the compatibilizing agent are melt mixed to form a first mixture and the metal stearate, polyolefin comprising functional groups reactive with the polyamide and the remaining polyamide are melt mixed with the first mixture.

23. The composition of claim 21 wherein the metal stearate comprises zinc stearate, calcium stearate, aluminum stearate, cerium stearate, magnesium stearate or a combination of two or more of the foregoing

24. The composition of claim 21 wherein the functional groups comprise carboxylic acid groups, esters, acid anhydrides, epoxy groups, oxazoline groups, carbodiimide groups, isocyanate groups, silanol groups, carboxylates or a combination of two or more of the foregoing.

25. The composition of claim 21 wherein the functional groups comprise more than one type of functional group.

26. The composition of claim 21 wherein the polyolefin comprising functional groups reactive with the polyamide comprises ethylene-propylene-graft-maleic anhydride.

27. The composition of claim 21 wherein the poly(arylene ether) and polyamide are compatibilized.

28. The composition of claim 21 further comprising an additive.

29. The composition of claim 28 wherein the additive is carbon black.

30. The composition of claim 21 further comprising an impact modifier.

31. The composition of claim 30 wherein the impact modifier is a block copolymer.

32. The composition of claim 21 wherein the impact modifier is present in an amount up to about 20 weight percent based on the total weight of the composition.

33. The composition of claim 21 wherein the poly(arylene ether) is present in an amount of about 20 to about 65 weight percent, based on the total weight of the composition.

34. The composition of claim 21 wherein the polyamide is present in an amount of about 35 to about 80 weight percent, based on the total weight of the composition.

35. The composition of claim 21 wherein the metal stearate is present in an amount of about 0.05 to about 1.0 weight percent, based on the total weight of the composition.

36. The composition of claim 21 wherein the polyolefin comprising functional groups reactive with the polyamide is present in an amount of about 1 to about 15 weight percent, based on the total weight of the composition.

37. The composition of claim 21 wherein the composition has a melt viscosity greater than or equal to about 130 Pascal seconds (Pas) when determined at 282° C. and a 1500 reciprocal seconds shear rate; a Dynatup impact strength (in joule, tested at 23° C.) greater than or equal to about 30 as determined according to ASTM D3763; and an ejector pressure less than or equal to about 1100 kilopascals when measured upon ejection of a four-way connector.

38. The composition of claim 21 wherein the composition has an impact strength greater than or equal to the impact strength of comparable poly(arylene ether)-polyamide composition free of metal stearates, functionalized polyolefins or combinations there of; a melt viscosity less than or equal to about 110% of the melt viscosity of comparable poly(arylene ether)-polyamide composition free of metal stearates, functionalized polyolefins or combinations there of; and an ejector pressure that is less than or equal to about 90% of the ejector pressure of a comparable poly(arylene ether)-polyamide composition free of metal stearates, functionalized polyolefins or combinations there of.

39. A thermoplastic composition comprising a poly(arylene ether), a polyamide, calcium stearate, an impact modifier and an ethylene-propylene-graft-maleic anhydride copolymer.

40. A thermoplastic composition consisting essentially of a poly(arylene ether), a polyamide, calcium stearate, an impact modifier, carbon black and a ethylene-propylene-graft-maleic anhydride copolymer.
